(19) United States
(12) Patent Application Publication
(10) Pub. No.: US 2026/0341132 A1
(43) Pub. Date: Oct. 29, 2026

(54) VIDEO SURVEILLANCE SYSTEM AND EVENT ANALYSIS MODULE FOR VIDEO SURVEILLANCE

(71) Applicant: SENAO NETWORKS, INC, Taoyuan (TW)

(72) Inventors: Bo-Sian WU, Taoyuan (TW); Chao-Pin Wu, Taoyuan (TW)

(21) Appl. No.: 19/281,981

(22) Filed: Jul. 28, 2025

(30) Foreign Application Priority Data
Apr. 25, 2025 (TW) 114115754

(51) Int. Cl. G08B 13/196; G06V 10/82; G06V 20/40; G06V 20/52

(52) U.S. Cl. CPC G08B 13/19691; G06V 10/82; G06V 20/40; G06V 20/52; G06V 2201/10

(57) ABSTRACT

A video surveillance system is provided. The video surveillance system comprises an image collection module and an event analysis module. The image collection module is configured to create at least one image dataset based on video(s) from at least one monitoring device. The event analysis module is configured to: initialize at least one background scenario, including several predefined events, based on the at least one image dataset; create at least one analysis prompt based on the at least one background scenario and one or more user-defined events; and input at least one analysis prompt to a generative artificial intelligence model in order to output at least one analysis result.

### CROSS-REFERENCE TO RELATED PATENT APPLICATION

This non-provisional application claims priority to and the benefit of, pursuant to 35 U.S.C. § 119(a), Taiwanese patent application No. 114115754, filed on Apr. 25, 2025, the disclosure of which is incorporated herein in its entirety by reference.

### FIELD OF INVENTION

The present invention relates to video surveillance technology, and more particularly to a video surveillance system and an event analysis module for video surveillance adopting generative artificial intelligence.

### BACKGROUND

As the demand for security in modern society continues to increase, surveillance systems are becoming more and more widely used in public places, commercial environments and private spaces. However, traditional surveillance systems only have recording and basic object detection functions, and usually require manual review of video data on a regular basis. They are unable to dynamically analyze events in video data, resulting in delayed responses to abnormal situations or failure to notify them immediately, as well as neglect of key events. As video resolution increases, the amount of data generated also increases dramatically, making it more difficult to effectively analyze and process such data.

### SUMMARY

One objective of the present invention is to use generative artificial intelligence combined with image data sampled by monitoring devices to conduct event analysis in order to accurately identify abnormal behavior, public safety threats or specific scenarios, thereby significantly improving the intelligence level of the surveillance system.

Another objective of the present invention is to design flexible event analysis parameters and notification methods (including mobile pushes, webpage notifications, etc.) based on the needs of users and the environment to ensure that users can grasp the situation in real time and take appropriate actions.

One embodiment of the present invention is directed to a video surveillance system comprising an image collection module and an event analysis module. The image collection module is configured to create at least one image dataset based on video(s) from at least one monitoring device. The event analysis module is configured to: initialize at least one background scenario, including several predefined events, based on at least one image dataset; create at least one analysis prompt based on at least one background scenario and one or more user-defined events; and input at least one analysis prompt to a generative artificial intelligence model in order to output at least one analysis result.

In some implementations, at least one image dataset has a structured key format comprising metadata selected from a group including time and monitoring device identifier.

In some implementations, the image collection module sends at least one image dataset to an object storage server for reception by the event analysis module.

In some implementations, at least one analysis prompt comprises at least one analysis model role.

In some implementations, at least one analysis prompt comprises at least one event analysis guide including several analysis objectives and several classification bases.

In some implementations, the generative artificial intelligence model is of generative pre-trained transformer (GPT) type.

In some implementations, the generative artificial intelligence model is configured to perform semantic inference and event classification.

In some implementations, the generative artificial intelligence model comprises a target monitor plugin configured to perform detection and tracking of several targets.

In some implementations, at least one analysis result respectively includes title, summary, event description, hazard level, keywords, event class, time series, or any combination thereof.

In some implementations, the event class includes security events, property damage, crowd management, traffic-related, or user-defined events, or any combination thereof.

In some implementations, at least one analysis result is of JavaScript Object Notation (JSON) format.

In some implementations, the video surveillance system further comprises an event notification module configured to: store at least one analysis result to a logging engine for subsequent query and visualization support; and conduct user event notification through a message broker server to at least one notification pathway based on at least one analysis result.

In some implementations, the notification pathway includes web event logs, emails, mobile pushes, text messages, instant messaging, smart devices, or any combination thereof.

Another embodiment of the present invention is directed to an event analysis module for video surveillance, wherein the event analysis module is configured to: initialize at least one background scenario, including several predefined events, based on at least one image dataset; create at least one analysis prompt based on at least one background scenario and one or more user-defined events; and input at least one analysis prompt to a generative artificial intelligence model in order to output at least one analysis result.

In some implementations, at least one image dataset has a structured key format comprising metadata selected from a group including time and monitoring device identifier.

In some implementations, at least one image dataset is received from an object storage server.

In some implementations, at least one analysis prompt comprises at least one analysis model role.

In some implementations, at least one analysis prompt comprises at least one event analysis guide including several analysis objectives and several classification bases.

In some implementations, the generative artificial intelligence model is of generative pre-trained transformer (GPT) type.

In some implementations, the generative artificial intelligence model is configured to perform semantic inference and event classification.

In some implementations, the generative artificial intelligence model comprises a target monitor plugin configured to perform detection and tracking of several targets.

In some implementations, at least one analysis result respectively includes title, summary, event description, hazard level, keywords, event class, time series, or any combination thereof.

In some implementations, the event class includes security events, property damage, crowd management, traffic-related, or user-defined events, or any combination thereof.

In some implementations, at least one analysis result is of JavaScript Object Notation (JSON) format.

### BRIEF DESCRIPTION OF THE DRAWINGS

FIG. 1 is a video surveillance system architecture diagram according to an embodiment of the present invention.

FIG. 2 is an image collection flowchart according to an embodiment of the present invention.

FIG. 3 is an event analysis flowchart according to an embodiment of the present invention.

FIG. 4 is an event notification flowchart according to an embodiment of the present invention.

### DETAILED DESCRIPTION

Features of the present invention are set forth below in connection with the appended drawings, for the purpose of providing a thorough view of various concepts while not intended to represent the only configurations in which the concepts described herein may be practiced. One of ordinary skill in the art may, after understanding embodiments of the present invention, change and modify the techniques taught herein without departing from the spirit and scope of the present invention.

The terms “include”, “comprises”, “have”, “contain”, etc. used herein are open-ended terms, meaning including but not limited to.

The term “and/or” used herein includes any or all combinations of the items described.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning consistent with their meaning in the context of the relevant art and the present invention, and will not be interpreted in an idealized or overly formal sense unless expressly so defined herein.

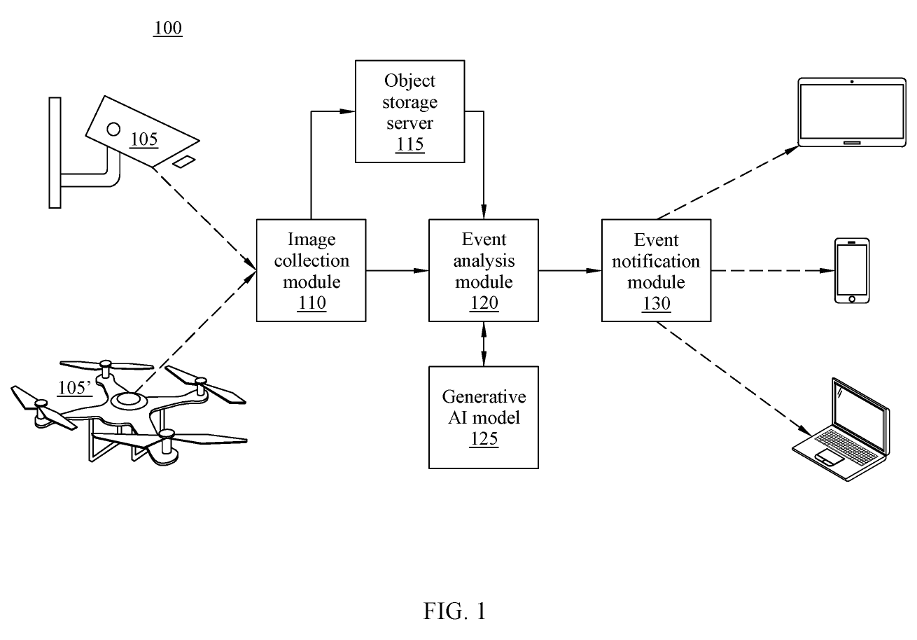

FIG. 1 is a video surveillance system architecture diagram according to an embodiment of the present invention. As shown in FIG. 1, a video surveillance system 100 comprises an image collection module 110, an event analysis module 120 and an optional event notification module 130. When at least one monitoring device 105 and/or 105’ detects the presence of an object such as a person or vehicle, the image collection module 110 is activated to create at least one image dataset based on video(s) from at least one monitoring device, e.g., by means of per-second sampling. The event analysis module 120 conducts per-frame analysis and initializes at least one background scenario (i.e., complete event content that can be classified and understood) based on the image dataset. A generative artificial intelligence model 125 then automatically analyzes various abnormal events to output at least one analysis result, and may support user-defined event classes. The event notification module 130 stores the analysis result to a logging engine according to user-defined parameters, and conducts user event notification like mobile push, web push, etc.

The monitoring device(s) 105 and/or 105’ may be IP cameras, smart door lock cameras, license plate recognition cameras, facial recognition cameras, thermal cameras, environmental monitoring cameras and other photographic equipment, and/or mobile equipment such as drone cameras, wearable cameras, smart doorbell cameras, etc. The image collection module 110, event analysis module 120 and/or event notification module 130 may be implemented as program code in computer-readable media, or in hardware apparatuses like application-specific integrated circuits (ASIC), or on cloud platforms such as Amazon Web Services, Google Cloud Platform, Microsoft Azure, Alibaba Cloud, Oracle Cloud, IBM Cloud, DigitalOcean, Linode, Vultr, Heroku, and Tencent Cloud, and the present invention is not limited thereto.

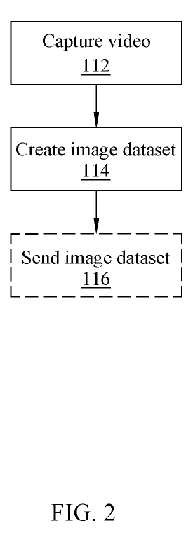

FIG. 2 is an image collection flowchart according to an embodiment of the present invention. As shown in FIG. 2, the image collection module 110 captures video from the monitoring device(s) 105 and/or 105’ (step 112), and creates at least one image dataset with time series (e.g., by means of per-second sampling) based on duration(s) of object presence (step 114). At least one image dataset may have a structured key format comprising metadata such as time and monitoring device identifier, to provide clear index information for subsequent processing. In some implementations, the image collection module 110 may be configured to send at least one image dataset to an object storage server 115 shown in FIG. 1 (step 116) for reception by the event analysis module 120. The object storage server 115 may be implemented, for example, by services like Amazon Web Services S3, Google Cloud Storage, Azure Blob Storage, Alibaba Cloud OSS, Oracle Cloud Storage, IBM Cloud Object Storage, etc.

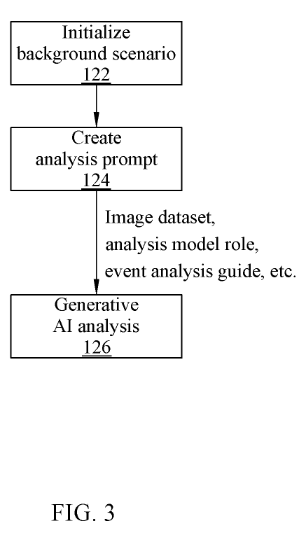

FIG. 3 is an event analysis flowchart according to an embodiment of the present invention. In some aspects, the image collection module 110 may trigger the event analysis module 120 after sending all image datasets to the object storage server 115. Firstly, at step 122, the event analysis module 120 initializes at least one background scenario including several predefined events that represent user focus (e.g., security events, property damage, crowd management, traffic-related) based on at least one image dataset; in some aspects, this step may comprise operations like obtaining monitoring device information, converting timestamp into local time, etc. At step 124, the event analysis module 120 creates at least one analysis prompt based on at least one background scenario and one or more user-defined events, to guide subsequent effective identification and classification of events; the user-defined events may be arrival of food delivery services, arrival of VIPs, wandering of suspicious persons, lost pets, package delivery, emergency medical events, environmental pollution events, weather-related events, etc. In some implementations, at least one analysis prompt comprises at least one analysis model role (e.g., image analyst) to facilitate objective event analysis for image datasets. In some implementations, at least one analysis prompt comprises at least one event analysis guide including several analysis objectives and several classification bases, to indicate results that users desire to the model. Analysis objectives may be, for example, people, vehicles, flames, smoke, stagnant water, etc. Classification bases may relate to predefined events and/or user-defined events.

After creation of at least one analysis prompt has been finished, the event analysis module 120 inputs, at step 126, at least one analysis prompt to the generative artificial intelligence (AI) model 125 in order to output at least one analysis result. The generative AI model 125 may be of generative pre-trained transformer (GPT) type, like OpenAI GPT-4, Google Gemini-1.5-flash, Azure OpenAI Service, Anthropic Claude, Meta Llama 2, Stability AI, Midjourney, DALL·E, etc., and the present invention is not limited thereto. The generative AI model 125 may be configured to perform semantic inference and event classification, and/or comprise a target monitor plugin configured to perform detection and tracking of several targets (e.g., people, vehicles, flames, smoke, stagnant water, etc.), to improve analysis efficiency and accuracy. At least one analysis result respectively includes, for example, title, summary, event description, hazard level, keywords, event class, or time series. The event class relating to event classification performed by the generative AI model 125 may include security events (intrusion, climbing fences, possession of weapons, fighting, bullying, kidnapping, robbery, etc.), property damage (graffiti vandalism, damaged goods, arson, littering, etc.), crowd management (crowd gathering, panic, falls, etc.), traffic-related (car accidents, illegal parking, etc.) corresponding to predefined events described for step 122, as well as user-defined events described for step 124. In some implementations, at least one analysis result may be of JavaScript Object Notation (JSON) format or other data exchange structures.

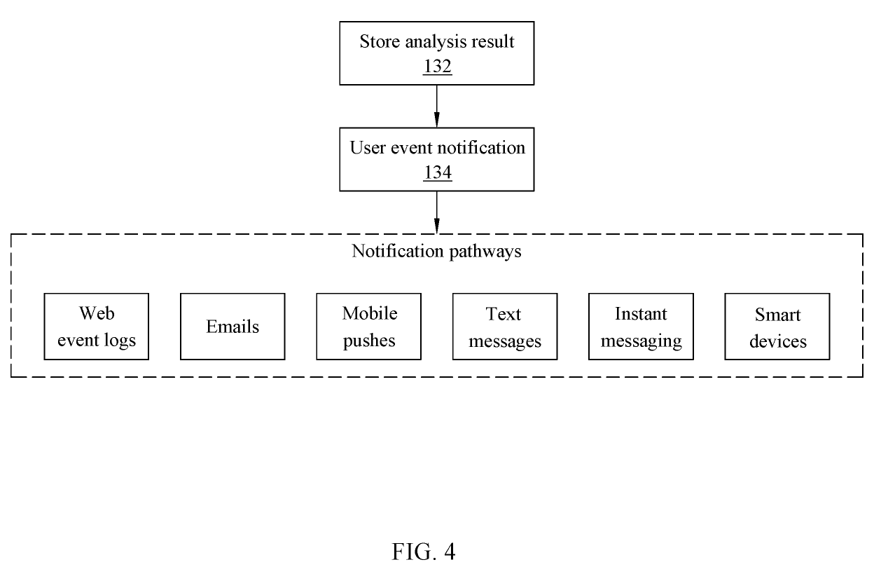

FIG. 4 is an event notification flowchart according to an embodiment of the present invention. As shown in FIG. 4, the event notification module 130 stores at least one analysis result from the generative AI model 125 to a logging engine for subsequent query and visualization support (step 132), and conducts user event notification through a message broker server to at least one notification pathway based on at least one analysis result (step 134). The logging engine (e.g., Elasticsearch) integrates a data collection and log-parsing engine as well as an analytics and visualization platform, and supports faceted search and percolating (a form of prospective search), which can be useful for notifying if new documents match for registered queries. The message broker server may be implemented, for example, by services like Apache Kafka, Redis Pub/Sub, RabbitMQ, AWS SNS/SQS, Google Cloud Pub/Sub, Azure Event Hub, MQTT Broker, etc. to provide a unified, high-throughput, low-latency platform for handling real-time data, and may integrate instant communication functionality like WebSocket, gRPC Streaming, etc. At least one notification pathway may include web event logs, emails, mobile pushes, text messages, instant messaging (LINE, Telegram, WhatsApp, WeChat, Slack, Discord, etc.), or smart devices (smart speakers, smart watches, smart displays, car systems, etc.).

Although the present invention has been disclosed as above by the embodiments, it is not intended to limit the present invention. One of ordinary skill in the art can make various changes and modifications without departing from the spirit and scope of the present invention. Accordingly, the scope of the present invention is to be accorded the broadest scope consistent with the appended claims rather than the foregoing description and the exemplary embodiments described therein.

What is claimed is:

1. A video surveillance system, comprising:
an image collection module configured to create at least one image dataset based on video from at least one monitoring device; and
an event analysis module configured to:
initialize at least one background scenario including several predefined events based on the at least one image dataset;
create at least one analysis prompt based on the at least one background scenario and one or more user-defined events; and
input the at least one analysis prompt to a generative artificial intelligence model in order to output at least one analysis result.

2. The video surveillance system of claim 1, wherein the at least one image dataset has a structured key format comprising metadata selected from a group including time and monitoring device identifier.

3. The video surveillance system of claim 1, wherein the image collection module sends the at least one image dataset to an object storage server for reception by the event analysis module.

4. The video surveillance system of claim 1, wherein the at least one analysis prompt comprises at least one analysis model role.

5. The video surveillance system of claim 1, wherein the at least one analysis prompt comprises at least one event analysis guide including several analysis objectives and several classification bases.

6. The video surveillance system of claim 1, wherein the generative artificial intelligence model is of generative pre-trained transformer (GPT) type.

7. The video surveillance system of claim 1, wherein the generative artificial intelligence model is configured to perform semantic inference and event classification.

8. The video surveillance system of claim 1, wherein the generative artificial intelligence model comprises a target monitor plugin configured to perform detection and tracking of several targets.

9. The video surveillance system of claim 1, wherein the at least one analysis result respectively includes title, summary, event description, hazard level, keywords, event class, time series, or any combination thereof.

10. The video surveillance system of claim 9, wherein the event class includes security events, property damage, crowd management, traffic-related, or user-defined events, or any combination thereof.

11. The video surveillance system of claim 1, wherein the at least one analysis result is of JavaScript Object Notation (JSON) format.

12. The video surveillance system of claim 1, further comprising an event notification module configured to:
store the at least one analysis result to a logging engine for subsequent query and visualization support; and
conduct user event notification through a message broker server to at least one notification pathway based on the at least one analysis result.

13. The video surveillance system of claim 12, wherein the at least one notification pathway includes web event logs, emails, mobile pushes, text messages, instant messaging, smart devices, or any combination thereof.

14. An event analysis module for video surveillance, the event analysis module configured to:
initialize at least one background scenario including several predefined events based on at least one image dataset;
create at least one analysis prompt based on the at least one background scenario and one or more user-defined events; and
input the at least one analysis prompt to a generative artificial intelligence model in order to output at least one analysis result.

15. The event analysis module of claim 14, wherein the at least one image dataset has a structured key format comprising metadata selected from a group including time and monitoring device identifier.

16. The event analysis module of claim 14, wherein the at least one image dataset is received from an object storage server.

17. The event analysis module of claim 14, wherein the at least one analysis prompt comprises at least one analysis model role.

18. The event analysis module of claim 14, wherein the at least one analysis prompt comprises at least one event analysis guide including several analysis objectives and several classification bases.

19. The event analysis module of claim 14, wherein the generative artificial intelligence model is of generative pre-trained transformer (GPT) type.

20. The event analysis module of claim 14, wherein the generative artificial intelligence model is configured to perform semantic inference and event classification.

21. The event analysis module of claim 14, wherein the generative artificial intelligence model comprises a target monitor plugin configured to perform detection and tracking of several targets.

22. The event analysis module of claim 14, wherein the at least one analysis result respectively include title, summary, event description, hazard level, keywords, event class, time series, or any combination thereof.

23. The event analysis module of claim 22, wherein the event class includes security events, property damage, crowd management, traffic-related, or user-defined events, or any combination thereof.

24. The event analysis module of claim 14, wherein the at least one analysis result is of JavaScript Object Notation (JSON) format.
